(19) United States
(12) Patent Application Publication
(10) Pub. No.: US 2007/0169584 A1
(43) Pub. Date: Jul. 26, 2007

(54) ADJUSTING DEVICE FOR PROJECTOR LENS

(75) Inventor: Yen Lin Wang, Taipei City (TW)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/625,239

(22) Filed: Jan. 19, 2007

(30) Foreign Application Priority Data
Jan. 20, 2006 (TW) TW95102199

(51) Int. Cl. F16H 35/00

(52) U.S. Cl. 74/640

(57) ABSTRACT

An adjusting device for a projector lens comprises a seat bearing a lens, a shaft connected to the seat which moving on the shaft to adjust lens positions when the shaft rotates, a first gear pivoted on the shaft, a second gear engaging the first gear, a motor rotating the second gear, and an torque limiter joined to the first gear and the shaft. The motor rotates the shaft via the first and second gears. When the torque rotating the shaft exceeds a predetermined value, the torque limiter releases the first gear from the shaft enabling the first gear to rotate relative to the shaft to intercept the torque transmitted from the motor to the shaft.

### BACKGROUND OF THE INVENTION

1. Field of the Invention

The invention relates to an adjusting device for a projector lens, and in particular to an adjusting device with torque limiting.

2. Description of the Related Art

In a conventional projector, a mechanism moving the lens of the projector is used to adjust the image position. When the lens is stopped by external force, for example the lens is moved to its limit, torque on the lens may increase. The increased reacting torque is transmitted back to a motor driving the mechanism and may damage the motor.

### BRIEF SUMMARY OF THE INVENTION

An embodiment of an adjusting device of the invention comprises a seat bearing a lens, a shaft connected to the seat which moves on the shaft to adjust lens positions when the shaft rotates, a first gear pivoted on the shaft, a second gear engaging the first gear, a motor rotating the second gear, and a torque limiter joined to the first gear and the shaft. The motor rotates the shaft via the first and second gears. When the torque rotating the shaft exceeds a predetermined value, the torque limiter releases the first gear from the shaft enabling the first gear to rotate relative to the shaft to intercept the torque transmitted from the motor to the shaft. In the embodiment, the torque limiter can be fixed to the shaft.

The torque limiter comprises a pressing plate biasing the first gear, whereby the first gear is pivoted on the shaft. When the torque rotating the shaft exceeds a predetermined value, the pressing plate releases the first gear from the shaft enabling the first gear to rotate relative to the shaft to intercept the torque transmitted from the motor to the shaft.

The pressing plate comprises at least one protrusion, and the first gear comprises a plurality of depressions corresponding thereto. When the pressing plate biases the first gear, the protrusion enters the depressions to join the shaft and the first gear. When the torque rotating the shaft exceeds a predetermined value, the protrusion leaves the depression, whereby the first gear is capable of rotating relative to the pressing plate.

The torque limiter further comprises a compression spring enabling the pressing plate to bias the first gear.

The torque limiter further comprises a washer and a bolt fixed to the shaft. The bolt positions the compression spring between the washer and the pressing plate. The bolt can be fixed to one end of the shaft.

The shaft has a screw portion with which the seat engages and moves on the shaft.

### BRIEF DESCRIPTION OF THE DRAWINGS

The invention can be more fully understood by reading the subsequent detailed description and examples with references made to the accompanying drawings, wherein:

FIG. 1 is a perspective view of an embodiment of an adjusting device for a projector lens of the invention;

FIG. 2 is a perspective view of an embodiment of an adjusting device for a projector lens of the invention;

FIG. 3 is an exploded view of an over torque protecting device of the invention; and

FIG. 4 is a cross section of an over torque protecting device of the invention.

### DETAILED DESCRIPTION OF THE INVENTION

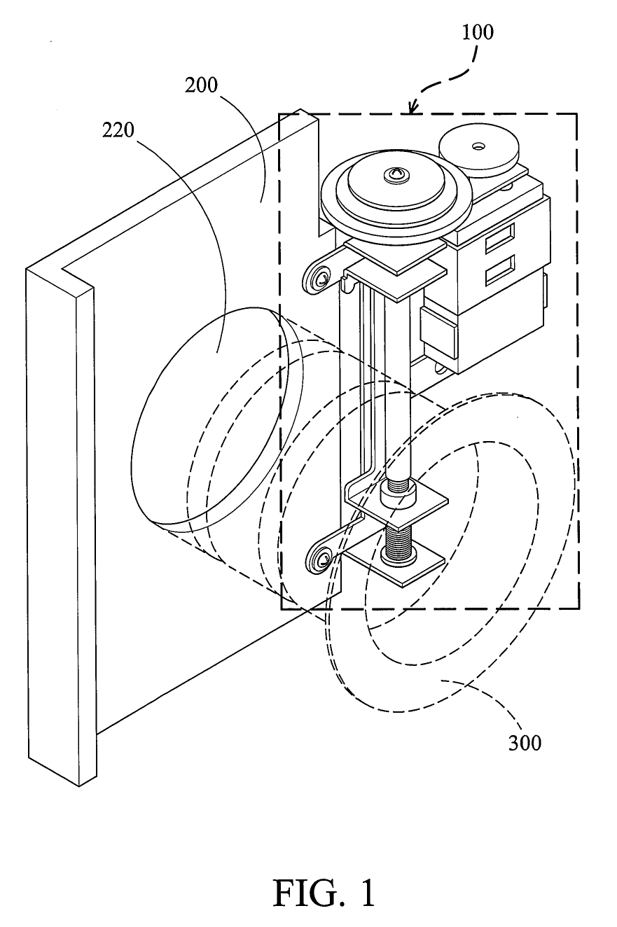

FIG. 1 depicts an embodiment of an adjusting device for a projector lens of the invention. The adjusting device 100 is fixed on a frame 200 with an opening 220. Light from a light source (not shown) enters a lens 300 on the front of the frame 200 through the opening 220.

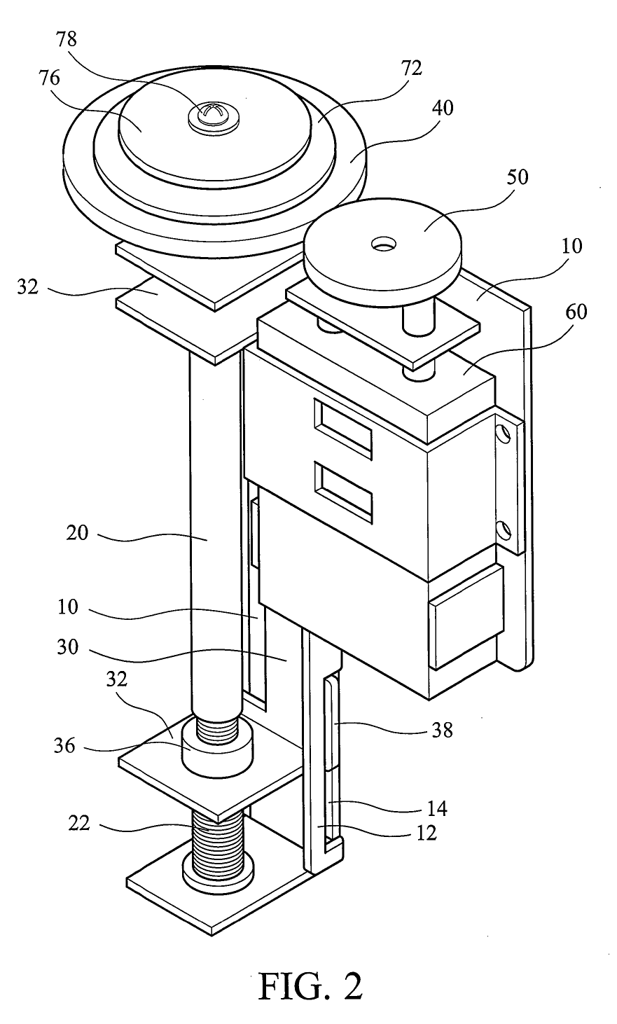

Referring to FIG. 2, the adjusting device 100 comprises a bracket 10, a shaft 20, a seat 30, a first gear 40, a second gear 50, a motor 60 and an torque limiter 70.

The bracket 10 is fixed to the frame 200. The shaft 20 is mounted on the bracket 10. A C-clamp (not shown) is disposed on one end of the shaft 20 to fix the shaft 20 to the bracket 10. A screw portion 22 is formed on the shaft 20. The lens 300 is joined to the seat 30 comprising flanges 32 on opposite sides. Each flange 32 has a through hole (not shown) which allows the shaft 20 to extend through. A ring 36 is disposed on one of the flanges 32. Screws formed on the inner side of the ring 36 engage the screw portion 22. When the shaft 20 rotates, seat 30 is moved along the shaft 20. The bracket 10 has a flange 12 comprising a groove 14. The seat 30 has a wing 38 inserted into the groove 14 and moved therein, whereby the movement of the seat 30 is limited by the groove 14.

The first gear 40 is pivoted on the shaft 20 and can rotate relative to the shaft 20. The torque limiter 70 joins the first gear 40 to the shaft 20 enabling the first gear 40 to rotate with the shaft 20 simultaneously, and releases the first gear 40 from the shaft 20 enabling the first gear 40 to rotate relative to the shaft 20. The motor 60 is mounted on the bracket 10. Output shaft of the motor 60 is joined to the second gear 50 engaging the first gear 40. Torque generated by the motor 60 is transmitted to the shaft 20 via the engaged first and second gears 40 and 50.

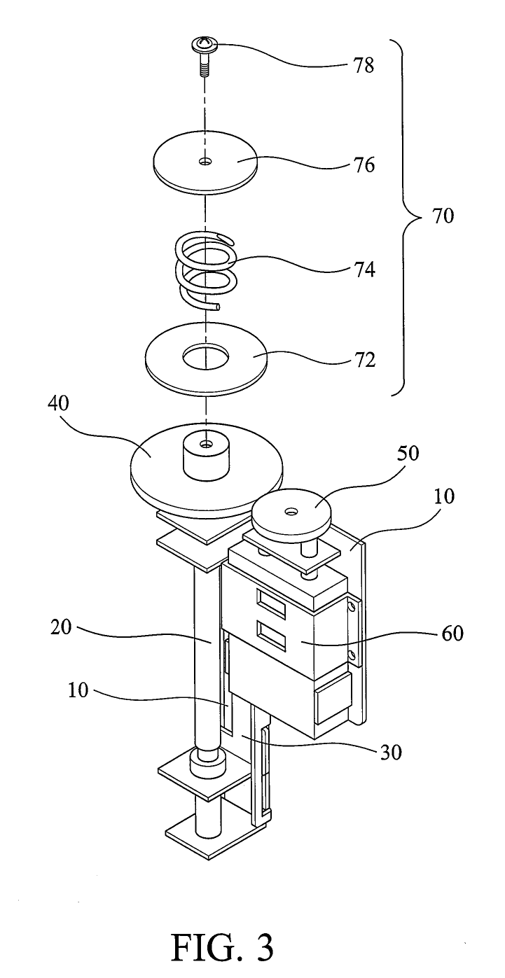

FIG. 3 is an exploded view of the torque limiter 70. The torque limiter 70 comprises a pressing plate 72, a compression spring 74, a washer 76 and a bolt 78. The pressing plate 72 contacts the first gear 40. The bolt 78 extends through the washer 76, the compression spring 74 and the pressing plate 72 and is fixed to one end of the shaft 20. As the compression spring 74 is compressed between the pressing plate 72 and the washer 76, the compression spring 74 biases the pressing plate 72 to abut the first gear 40.

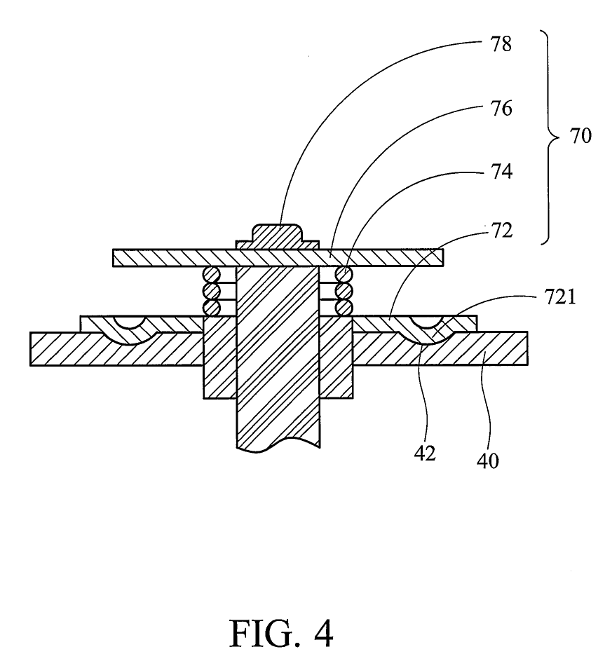

Referring to FIG. 4, the pressing plate has two protrusions 721. The first gear 40 has a plurality of depressions 42 formed on the side contacting the pressing plate 72. When the pressing plate 72 abuts the first gear 40 via the compression spring 74, the protrusions 721 enters the depressions 42, whereby the first gear 40 is joined to the shaft 20 by the torque limiter 70 and rotates with the shaft 20 simultaneously. When the seat 30 moves to a limit, i.e. the wing 38 abuts the end of the groove 14, resistance against the rotation of the shaft 20 is increased with the torque transmitted from the motor 60 to the shaft 20 increasing accordingly. When the torque exceeds a predetermined value, the protrusions 721 leave the depressions 42, whereby the first gear 40 is released from the shaft 20. At this time, the first gear 40 continues to rotate via the motor 60. Because the first gear 40 is released from the shaft 20, torque transmitted to the shaft 20 is reduced rapidly, whereby the motor 60 is protected from damage.

If sufficient torque is still present, the protrusions 721 continuously enter and leave the depressions 42. The predetermined value of torque can be set by the biasing force of the compression spring 74. The number of protrusions is not limited to two, only one or more protrusions are applicable. The positions of protrusion and depression can be exchanged.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. Adjusting device for a projector lens, comprising:
a seat bearing a lens;
a shaft connected to the seat, moving on the shaft to adjust lens position when the shaft rotates;
a first gear pivoted on the shaft;
a second gear engaging the first gear;
a motor rotating the second gear; and
an torque limiter joined to the first gear and the shaft, wherein the motor rotates the shaft via the first and second gears, and when a torque rotating the shaft exceeds a predetermined value, the torque limiter releases the first gear from the shaft enabling the first gear to rotate relative to the shaft to intercept the torque transmitted from the motor to the shaft.

2. The adjusting device as claimed in claim 1, wherein the torque limiter is fixed to the shaft.

3. The adjusting device as claimed in claim 1, wherein the torque limiter comprises a pressing plate biasing the first gear, whereby the first gear is pivoted on the shaft, and when the torque rotating the shaft exceeds a predetermined value, the pressing plate releases the first gear from the shaft enabling the first gear to rotate relative to the shaft to intercept the torque transmitted from the motor to the shaft.

4. The adjusting device as claimed in claim 3, wherein the pressing plate comprises at least one protrusion, and the first gear comprises a plurality of depressions corresponding to the protrusion, and when the pressing plate biases the first gear, the protrusion enters the depression to join the shaft and the first gear, and when the torque rotating the shaft exceeds a predetermined value, the protrusion leaves the depression, whereby the first gear rotates relative to the pressing plate.

5. The adjusting device as claimed in claim 3, wherein the torque limiter further comprises a compression spring enabling the pressing plate to bias the first gear.

6. The adjusting device as claimed in claim 5, wherein the torque limiter further comprises a washer and a bolt fixed to the shaft to position the compression spring between the washer and the pressing plate.

7. The adjusting device as claimed in claim 6, wherein the bolt is fixed to one end of the shaft.

8. The adjusting device as claimed in claim 1, wherein the shaft comprises a screw portion with which the seat engages and moves on the shaft.

9. The adjusting device as claimed in claim 3, wherein the pressing plate comprises at least one depression, and the first gear comprises a plurality of protrusions corresponding to the depression, and when the pressing plate biases the first gear, the depression engaged with the protrusion to join the shaft and the first gear, and when the torque rotating the shaft exceeds a predetermined value, the protrusion leaves the depression, whereby the first gear rotates relative to the pressing plate.
